(19) United States
(12) Patent Application Publication
(10) Pub. No.: US 2023/0128476 A1
(43) Pub. Date: Apr. 27, 2023

(54) RESIN MATERIAL AND METAL SUBSTRATE

(71) Applicant: NAN YA PLASTICS CORPORATION, TAIPEI (TW)

(72) Inventors: TE-CHAO LIAO, TAIPEI (TW); HUNG-YI CHANG, TAIPEI (TW); CHIEN-KAI WEI, TAIPEI (TW); CHIA-LIN LIU, TAIPEI (TW); WEI-RU HUANG, TAIPEI (TW)

(21) Appl. No.: 17/885,993

(22) Filed: Aug. 11, 2022

(30) Foreign Application Priority Data
Oct. 25, 2021 (TW) 110139407

(51) Int. Cl. C08F 36/06; C08F 212/08; C08G 65/48; C08K 3/36; C08K 9/04; C08K 5/3492; C08K 5/5425

(52) U.S. Cl. CPC C08F 36/06; C08F 212/08; C08G 65/485; C08K 3/36; C08K 9/04; C08K 5/34924; C08K 5/5425; C08G 2650/04; C08K 2201/005; C08F 2810/20

(57) ABSTRACT

A resin material and a metal substrate are provided. The resin material includes a resin composition and inorganic fillers. The inorganic fillers are dispersed in the resin composition. The resin composition includes 10 wt % to 40 wt % of a liquid rubber, 20 wt % to 50 wt % of a polyphenylene ether resin, and 10 wt % to 30 wt % of a crosslinker. The polyphenylene ether resin includes a first polyphenylene ether that has a bismaleimide group at a molecular end.

### CROSS-REFERENCE TO RELATED PATENT APPLICATION

This application claims the benefit of priority to Taiwan Patent Application No. 110139407, filed on Oct. 25, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin material and a metal substrate, and more particularly to a low-dielectric resin material and a low-dielectric metal substrate.

### BACKGROUND OF THE DISCLOSURE

With the development of the fifth generation wireless system (5G wireless system), high frequency transmission has become a main trend for meeting requirements for the 5G wireless system. Accordingly, one of the priorities in the relevant industry is to develop a resin material for high frequency (a frequency ranging from 28 GHz to 60 GHz) transmission.

The resin material is to have a low dielectric constant (Dk) and a low dielectric dissipation factor (Df), so as to have high applicability for high frequency transmission. In this specification, the dielectric constant and the dielectric dissipation factor are collectively referred to as dielectric properties of the resin material. Specific requirements to the dielectric properties are a dielectric constant not higher than 3.0 and a dielectric dissipation factor not higher than 0.0016 that are measured at a frequency of 10 GHz.

A resin material on the market usually contains a certain amount of liquid rubber which can decrease the dielectric properties of the resin material. However, the liquid rubber cannot be added without limit. When an amount of the liquid rubber is too high, a glass transition temperature (Tg) of the resin material decreases, and a peeling strength between the resin material and a metal layer decreases.

Therefore, how to adjust the components of the resin material so as to allow the resin material to possess good thermal resistance, good peeling strength, and good dielectric properties has become an important issue in the related art.

### SUMMARY OF THE DISCLOSURE

In response to the above-referenced technical inadequacies, the present disclosure provides a resin material and a metal substrate.

In one aspect, the present disclosure provides a resin material. The resin material includes a resin composition and inorganic fillers. The inorganic fillers are dispersed in the resin composition. The resin composition includes 10 wt % to 40 wt % of a liquid rubber, 20 wt % to 50 wt % of a polyphenylene ether resin, and 10 wt % to 30 wt % of a crosslinker. The polyphenylene ether resin includes a first polyphenylene ether that has a bismaleimide group at a molecular end.

In certain embodiments, a number average molecular weight of the first polyphenylene ether ranges from 1500 g/mol to 5000 g/mol.

In certain embodiments, a hydroxyl value of the first polyphenylene ether is lower than 0.5 mgKOH/g.

In certain embodiments, an average quantity of the bismaleimide group in the first polyphenylene ether ranges from 1 to 2.

In certain embodiments, the polyphenylene ether resin further includes a second polyphenylene ether, a third polyphenylene ether, or a combination thereof. The second polyphenylene ether has a methacrylate group at a molecular end, and the third polyphenylene ether has a methacrylate group at a styryl group at a molecular end.

In certain embodiments, a number average molecular weight of the liquid rubber ranges from 2000 g/mol to 6000 g/mol.

In certain embodiments, a material for polymerizing the liquid rubber includes a butadiene monomer. Based on a total amount of the butadiene monomer being 100 mol %, 30 mol % to 90 mol % of the butadiene monomer has a side chain that contains an ethylene group after polymerization.

In certain embodiments, a material for polymerizing the liquid rubber includes a styrene monomer. Based on a total amount of the liquid rubber being 100 mol %, an amount of the styrene monomer ranges from 10 mol % to 50 mol %.

In certain embodiments, based on a total weight of the resin composition being 100 phr, an amount of the inorganic fillers ranges from 20 phr to 150 phr.

In certain embodiments, the inorganic fillers are processed by a surface modification process to have at least one of a methacrylate group and an ethylene group.

In certain embodiments, the inorganic fillers include at least one of silicon dioxide, strontium titanate, calcium titanate, titanium dioxide, and alumina.

In certain embodiments, a purity of the inorganic fillers is higher than or equal to 99.8%.

In certain embodiments, an average particle size of the inorganic fillers ranges from 0.3 μm to 3 μm, and a maximum particle size of the inorganic fillers is smaller than 10 μm.

In certain embodiments, the resin material further includes a siloxane coupling agent which has at least one of a methacrylate group and an ethylene group.

In certain embodiments, based on a total weight of the resin composition being 100 phr, an amount of the siloxane coupling agent ranges from 0.1 phr to 5 phr.

In another aspect, the present disclosure provides a metal substrate. The metal substrate includes a base layer and a metal layer. The metal layer is disposed on the base layer. The base layer is formed from a resin material. The resin material includes a resin composition and inorganic fillers that is dispersed in the resin composition. The resin composition includes 10 wt % to 40 wt % of a liquid rubber, 20 wt % to 50 wt % of a polyphenylene ether resin, and 10 wt % to 30 wt % of a crosslinker. The polyphenylene ether resin includes a first polyphenylene ether that has a bismaleimide group at a molecular end.

In certain embodiments, a dielectric dissipation factor of the resin material measured at 10 GHz is lower than or equal to 0.0016.

In certain embodiments, a dielectric constant of the resin material measured at 10 GHz is lower than or equal to 3.0.

In certain embodiments, a glass transition temperature of the resin material ranges from 150° C. to 250° C.

In certain embodiments, a peeling strength of the metal substrate ranges from 6.0 lb/in to 7.5 lb/in.

Therefore, in the resin material and the metal substrate provided by the present disclosure, by virtue of “the polyphenylene ether resin including the first polyphenylene ether that has a bismaleimide group at a molecular end,” the resin material can have good dielectric properties, good thermal resistance, and good peeling strength with the metal layer.

These and other aspects of the present disclosure will become apparent from the following description of the embodiment taken in conjunction with the following, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

[Resin Material]

The present disclosure addresses the problem of poor thermal resistance and poor peeling strength in a resin material due to an excessive amount of the liquid rubber by adding a specific polyphenylene ether resin. Moreover, after adding the polyphenylene ether resin, the resin material can avoid having poor dielectric properties (high dielectric constant and high dielectric dissipation factor). In other words, by using the specific polyphenylene ether resin of the present disclosure, the resin material can have a good thermal resistance, a good peeling strength, and good dielectric properties.

Specifically, the resin material of the present disclosure includes a resin composition and inorganic fillers. The inorganic fillers are dispersed in the resin composition. Specific properties of the resin composition and the inorganic fillers are illustrated as follows.

[Resin Composition]

The resin composition of the present disclosure includes: 10 wt % to 40 wt % of the liquid rubber, 20 wt % to 50 wt % of a polyphenylene ether resin, and 10 wt % to 30 wt % of a crosslinker.

Through the aforesaid components and the contents of the resin composition, the resin material of the present disclosure can be used to manufacture a metal substrate that has good thermal resistance and good dielectric properties, so as to be applicable for high frequency transmission. In addition, the resin material can have a strong adhesive force with a metal layer (i.e. appropriate peeling strength). Results from property tests performed on the resin material and the metal substrate are provided below.

The resin material of the present disclosure contains the liquid rubber. The liquid rubber has a high solubility so as to enhance the compatibility of the components in the resin material. In addition, the liquid rubber has reactive functional groups which can enhance a crosslinking degree of the resin material after solidification.

When the liquid rubber of the present disclosure has a number average molecular weight ranging from 2000 g/mol to 6000 g/mol, flowability of the resin composition can be enhanced. Accordingly, a glue filling property of the resin composition can also be enhanced. Preferably, the number average molecular weight of the liquid rubber ranges from 2200 g/mol to 5500 g/mol. More preferably, the number average molecular weight of the liquid rubber ranges from 2500 g/mol to 4000 g/mol.

Based on a total weight of the resin composition being 100 wt %, an amount of the liquid rubber ranges from 10 wt % to 40 wt %. In some embodiments, based on the total weight of the resin composition being 100 wt %, the amount of the liquid rubber can be 15 wt %, 20 wt %, 25 wt %, 30 wt %, or 35 wt %.

In some embodiments, the liquid rubber incudes a liquid diene rubber. Preferably, the liquid diene rubber has a high ratio of a side chain that contains an ethylene group, especially for a liquid diene rubber that has a high ratio of a side chain containing 1,2-ethylene group.

When the liquid rubber has at least one of an unsaturated side chain that contains an ethylene group (or an ethylene side chain). A crosslink density and the thermal resistance of the resin composition after being crosslinked can both be enhanced. Specifically, a material to polymerize the liquid rubber includes a butadiene monomer. The liquid rubber can be polymerized from only the butadiene monomer or polymerized from the butadiene monomer and other monomers. In other words, the liquid rubber can be a butadiene homopolymer or a butadiene copolymer. Preferably, the liquid rubber is the butadiene homopolymer.

When the material to polymerize the liquid rubber includes the butadiene monomer, based on a total amount of the butadiene monomer being 100 mol %, an amount of the butadiene monomer that has the side chain containing the ethylene group after polymerization ranges from 30 mol % to 90 mol %. In some embodiments, based on the total amount of the butadiene monomer being 100 mol %, the amount of the butadiene monomer that has the side chain containing the ethylene group after polymerization can be 40 mol %, 50 mol %, 60 mol %, 70 mol %, or 80 mol %. Preferably, the amount of the butadiene monomer that has the side chain containing the ethylene group after polymerization ranges from 45 mol % to 75 mol %.

In some embodiments, the liquid rubber is polymerized from the butadiene monomer and a styrene monomer. Based on the total amount of the liquid rubber being 100 mol %, an amount of the styrene monomer ranges from 10 mol % to 50 mol %. When the amount of the styrene monomer ranges from 10 mol % to 50 mol %, a structure of the liquid rubber is likely to be similar to the structure of liquid crystal, such that the thermal resistance and the compatibility of the liquid rubber can both be enhanced.

The polyphenylene ether resin of the present disclosure at least includes a first polyphenylene ether. The first polyphenylene ether has a bismaleimide group at a molecular end. The first polyphenylene ether has a main structure of polyphenylene ether, such that the dielectric properties and the glass transition temperature of the resin material can be enhanced. The bismaleimide group of the first polyphenylene ether provides an unsaturated bond which is beneficial for crosslinking, such that the peeling strength of the resin material can be enhanced.

Therefore, the addition of the first polyphenylene ether can improve the dielectric properties, the glass transition temperature, and the peeling strength of the resin material. Furthermore, the addition of the first polyphenylene ether can decrease the amount of the liquid rubber.

In an exemplary embodiment, a number average molecular weight of the first polyphenylene ether of the present disclosure ranges from 1500 g/mol to 5000 g/mol. Preferably, the number average molecular weight of the first polyphenylene ether of the present disclosure ranges from 1500 g/mol to 4500 g/mol. More preferably, the number average molecular weight of the first polyphenylene ether of the present disclosure ranges from 1500 g/mol to 3500 g/mol.

In a preferable embodiment, an average quantity of the bismaleimide group of the first polyphenylene ether ranges from 1 to 2. A hydroxyl value of the first polyphenylene ether is lower than 0.5 mgKOH/g.

In addition to the first polyphenylene ether, the polyphenylene ether resin can include others polyphenylene ether, such as polyphenylene ether having a hydroxyl group at a molecular end, polyphenylene ether having a methacrylate group at a molecular end, polyphenylene ether having a styryl group at a molecular end, or polyphenylene ether having an epoxy group at a molecular end. However, the present disclosure is not limited thereto.

In a preferable embodiment, the polyphenylene ether resin further includes a second polyphenylene ether, a third the polyphenylene ether, or a combination thereof. The second polyphenylene ether has a methacrylate group at a molecular end. The third polyphenylene ether has a styryl group at a molecular end.

In a preferable embodiment, a ratio of an amount of the second polyphenylene ether to the amount of the first polyphenylene ether ranges from 1 to 2. A ratio of an amount of the third polyphenylene ether to the amount of the first polyphenylene ether ranges from 0.2 to 1.6.

It is worth noting that a bismaleimide resin in a conventional resin material can be replaced by the first polyphenylene ether of the present disclosure. In other words, a bismaleimide resin can be absent from the resin material of the present disclosure. Accordingly, varieties of the components in the resin material can be decreased, such that the compatibility of the resin material can relatively be enhanced, and the amount of the liquid rubber can be appropriately decreased.

Based on the total weight of the resin composition being 100 wt %, an amount of the polyphenylene ether resin ranges from 20 wt % to 50 wt %. In some embodiments, based on the total weight of the resin composition being 100 wt %, the amount of the polyphenylene ether resin can be 25 wt %, 30 wt %, 35 wt %, 40 wt %, or 45 wt %.

The crosslinker of the present disclosure can enhance a crosslink extent of the polyphenylene ether resin and the liquid rubber. In an exemplary embodiment, the crosslinker can include an allyl group. For example, the crosslinker can be triallyl cyanurate (TAC), triallyl isocyanurate (TAIC), diallyl phthalate, divinylbenzene, triallyl trimellitate, or any combination thereof. Preferably, the crosslinker can be triallyl isocyanurate. However, the present disclosure is not limited thereto.

In some embodiments, based on the total weight of the resin composition being 100 wt %, the amount of the crosslinker ranges from 10 wt % to 30 wt %. Preferably, the amount of the crosslinker can be 15 wt %, 20 wt %, or 25 wt %.

[Inorganic Fillers]

An addition of the inorganic fillers can help decrease the viscosity and the dielectric constant of the resin material. Some kinds of the inorganic fillers can also enhance the thermal conductivity of the resin material. The aforementioned description above are for illustration purposes only, the present disclosure is not limited thereto.

In the present disclosure, the inorganic fillers include silicon dioxide, strontium titanate, calcium titanate, titanium dioxide, alumina, or any combination thereof. However, the present disclosure is not limited thereto. In a preferable embodiment, the inorganic fillers include silicon dioxide, alumina, and titanium dioxide at the same time. In addition, silicon dioxide can be replaced by strontium titanate, calcium titanate, or a combination thereof. Silicon dioxide can be fused silica or crystalline silica. Preferably, the silicon dioxide is fused silica.

In a preferable embodiment, the inorganic fillers are processed by a surface modification process to have at least one of a methacrylate group and an ethylene group. Therefore, the inorganic fillers can react with the liquid rubber such that the resin composition can have a good compatibility with the inorganic fillers, and the thermal resistance of the metal substrate is not negatively influenced.

It should be noted that the inorganic fillers can include only one kind component or include various kinds of components. In addition, the inorganic fillers can be entirely processed by the surface modification, or only a part of the inorganic fillers is processed by the surface modification, so as to have at least one of the methacrylate group and the ethylene group. For example, in one embodiment, when the inorganic fillers include silicon dioxide and alumina, silicon dioxide is processed by the surface modification to have at least one of the methacrylate group and the ethylene group, while alumina is not processed by the surface modification. However, the present disclosure is not limited thereto.

An appearance of the inorganic fillers can be granular. An average particle size (D50) of the inorganic fillers ranges from 0.3 μm to 3 μm. The particle size (D99) of the inorganic fillers is lower than 10 μm, such that the inorganic fillers can be uniformly dispersed in the resin composition. In some embodiments, a purity of the inorganic fillers is higher than or equal to 99.8%.

An amount of the inorganic fillers can be adjusted according to requirements of products. In an exemplary embodiment, based on the total weight of the resin composition being 100 phr, the amount of the inorganic fillers ranges from 20 phr to 150 phr. Preferably, the amount of the inorganic fillers ranges from 30 phr to 120 phr. More preferably, the amount of the inorganic fillers ranges from 40 phr to 100 phr. However, the present disclosure is not limited thereto.

[Siloxane Coupling Agent]

The resin material can further include a siloxane coupling agent. Due to an addition of the siloxane coupling agent, a reactivity and a compatibility between a fiber cloth, the resin composition, and the inorganic fillers can be enhanced, thereby increasing the peeling strength and thermal resistance of the metal substrate.

In a preferable embodiment, the siloxane coupling agent has at least one of a methacrylate group and an ethylene group. A molecular weight of the siloxane coupling agent ranges from 100 g/mol to 500 g/mol. Preferably, the molecular weight of the siloxane coupling agent ranges from 110 g/mol to 250 g/mol. More preferably, the molecular weight of the siloxane coupling agent ranges from 120 g/mol to 200 g/mol.

Based on the total weight of the resin composition being 100 phr, the amount of the siloxane coupling agent ranges from 0.1 phr to 5 phr. Preferably, the amount of the siloxane coupling agent ranges from 0.5 phr to 3 phr.

[Catalyst]

The resin material can further include a catalyst. The catalyst facilitates the solidification of the resin material to form the high frequency substrate. Based on the total weight of the resin composition being 100 phr, the amount of the catalyst ranges from 0.25 phr to 1.5 phr.

For example, the catalyst can be imidazole compounds, such as triphenylimidazole, 2-ethyl-4-methylimidazole (2E4MZ), 1-Benzyl-2-phenylimidazole (1B2PZ), 1-cyanoethyl-2-phenylimidazole (2PZ-CN), or 2,3-dihydro-1H-pyrrole[1,2-a]benzimidazole (TBZ). However, the present disclosure is not limited thereto.

[Property Test]

In order to prove that the resin material can be used as the high frequency substrate material, 10 wt % to 40 wt % of the liquid rubber, 20 wt % to 50 wt % of the polyphenylene ether resin, and 10 wt % to 30 wt % of the crosslinker are mixed to form the resin composition. The inorganic fillers are further added into the resin composition to form the resin material of Examples 1 to 6 (E1 to E6). The inorganic fillers are added in another resin composition different from the aforesaid resin composition to form the resin material of Comparative Examples 1 to 2 (C1 to C2). Specific contents of the resin material of Examples 1 to 6 and Comparative Examples 1 to 2 are listed in Table 1. The glass transition temperature, the dielectric constant, and the dielectric dissipation of the resin material in each of Examples 1 to 6 and Comparative Examples 1 to 2 are listed in Table 2.

Subsequently, a fiber cloth is immersed into the resin material in each of Examples 1 to 6 and Comparative Examples 1 to 2. After being immersed, dried, and modeled, a prepreg is obtained. After the prepreg is processed, a metal layer is disposed on the prepreg so as to form the metal substrate in each of Examples 1 to 6 and Comparative Examples 1 to 2. The peeling strength and the thermal resistance of the metal substrate in each of Examples 1 to 6 and Comparative Examples 1 to 2 are listed in Table 2.

In Table 1, a molecular weight of the polybutadiene is 1200 g/mol, and the polybutadiene contains 85 mol % of 1,2-ethylene group side chain. A molecular weight of the butadiene/styrene copolymer is 8600 g/mol. The butadiene/styrene copolymer contains 17 mol % to 27 mol % of styrene monomer. The butadiene/styrene copolymer contains 40 mol % of 1,2-ethylene group side chain.

In Table 2, the properties of the resin material/the metal substrate are measured by methods below.
(1) Glass transition temperature: measuring the glass transition temperature of the resin material by a dynamic mechanical analyzer (DMA);
(2) Dielectric constant (10 GHz): detecting the dielectric constant of the resin material at 10 GHz by a dielectric analyzer (model: HP Agilent E4991A);
(3) Dielectric dissipation factor (10 GHz): detecting the dielectric dissipation factor of the resin material at 10 GHz by a dielectric analyzer (model: HP Agilent transition temperature);
(4) Peeling strength: measuring the peeling strength of the metal substrate according to the standard method of IPC-TM-650-2.4.8;
(5) Thermal resistance: heating the metal substrate in an autoclave with a temperature of 120° C. and a pressure of 2 atm, and then putting the metal substrate into a soldering furnace of 288° C. to calculate duration for a delamination process. If the duration of the delamination process is longer than 10 minutes, a term “OK” is shown in Table 1. If the duration of the delamination is shorter than 10 minutes, a term “NG” is shown in Table 1.

TABLE 1

| (phr) | | E1 | E2 | E3 | E4 | E5 | E6 | C1 | C2 |
|---|---|---|---|---|---|---|---|---|---|
| Liquid | polybutadiene | 40 | 20 | 20 | 20 | 20 | 20 | 20 | 20 |
| rubber | butadiene/styrene | 0 | 20 | 20 | 20 | 20 | 20 | 20 | 20 |
| | copolymer | | | | | | | | |

| | | | | | | | | |
|---|---|---|---|---|---|---|---|---|
| Polyphenylene ether having | 18 | 18 | 14 | 15 | 18 | 18 | 0 | 0 |
| bismaleimide group at molecular | | | | | | | | |
| end | | | | | | | | |
| Polyphenylene ether having | 18 | 18 | 28 | 22.5 | 27 | 0 | 45 | 0 |
| methacrylate group at molecular | | | | | | | | |
| end | | | | | | | | |
| Polyphenylene ether having | 9 | 9 | 3 | 7.5 | 0 | 27 | 0 | 45 |
| styryl group at molecular end | | | | | | | | |
| Crosslinker | 15 | 15 | 15 | 15 | 15 | 15 | 15 | 15 |
| Inorganic filler (silicon dioxide) | 40 | 40 | 40 | 40 | 40 | 40 | 40 | 40 |

TABLE 2

| | E1 | E2 | E3 | E4 | E5 | E6 | C1 | C2 |
|---|---|---|---|---|---|---|---|---|
| Glass transition | 219 | 215 | 218 | 220 | 216 | 218 | 205 | 208 |
| temperature | | | | | | | | |
| (° C.) | | | | | | | | |
| Dielectric | 3.0 | 3.0 | 3.0 | 3.0 | 3.0 | 3.0 | 3.0 | 3.0 |
| constant | | | | | | | | |
| (10 GHz) | | | | | | | | |
| Dielectric | 1.6 | 1.5 | 1.5 | 1.6 | 1.6 | 1.5 | 1.7 | 1.7 |
| dissipation | | | | | | | | |
| factor (10 | | | | | | | | |
| GHz) × 10³ | | | | | | | | |
| Peeling | 6.8 | 7.0 | 6.8 | 6.7 | 6.8 | 7.0 | 4.4 | 4.5 |
| strength | | | | | | | | |
| (lb/in) | | | | | | | | |
| Thermal | OK | OK | OK | OK | OK | OK | OK | OK |
| resistance | | | | | | | | |

According to Table 1 and Table 2, the addition of the first polyphenylene ether enables the resin material of the present disclosure to have good dielectric properties, good thermal resistance, and good peeling strength. Specifically, the dielectric constant (10 GHz) of the resin material is lower than or equal to 3.0. The dielectric dissipation factor (10 GHz) of the resin material is lower than or equal to 0.0016. The glass transition temperature of the resin material ranges from 210° C. to 230° C. The peeling strength of the resin material ranges from 6.5 lb/in to 7.0 lb/in.

According to Examples 1 to 6 and Comparative Examples 1 and 2, the addition of the first polyphenylene ether (i.e., the polyphenylene ether having a bismaleimide group at a molecular end) can enhance the peeling strength of the metal substrate to be higher than 5.0 lb/in (or even higher than 6.5 lb/in). Therefore, a bismaleimide resin can be absent from the resin material of the present disclosure.

[Beneficial Effects of the Embodiments]

In conclusion, in the resin material and the metal substrate provided by the present disclosure, by virtue of “the polyphenylene ether resin including the first polyphenylene ether that has a bismaleimide group at a molecular end,” the resin material can have good dielectric properties, good thermal resistance, and good peeling strength with the metal layer.

Further, by virtue of “the average number molecular weight of the first polyphenylene ether ranging from 1500 g/mol to 5000 g/mol,” the resin composition of the present disclosure can have good flowability.

Further, by virtue of “the hydroxyl value of the first polyphenylene ether being lower than 0.5 mg KOH/g,” the resin material can have good peeling strength with the metal layer.

Further, by virtue of “the polyphenylene ether resin including the second polyphenylene ether, the third polyphenylene ether, or a combination thereof, the second polyphenylene ether having a methacrylate group at a molecular end, and the third polyphenylene ether having a styryl group at a molecular end,” the resin composition can have good compatibility.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A resin material, comprising a resin composition and inorganic fillers that is dispersed in the resin composition, wherein the resin composition includes:
10 wt % to 40 wt % of a liquid rubber;
20 wt % to 50 wt % of a polyphenylene ether resin, wherein the polyphenylene ether resin includes a first polyphenylene ether that has a bismaleimide group at a molecular end; and
10 wt % to 30 wt % of a crosslinker.

2. The resin material according to claim 1, wherein a number average molecular weight of the first polyphenylene ether ranges from 1500 g/mol to 5000 g/mol.

3. The resin material according to claim 1, wherein a hydroxyl value of the first polyphenylene ether is lower than 0.5 mgKOH/g.

4. The resin material according to claim 1, wherein an average quantity of the bismaleimide group in the first polyphenylene ether ranges from 1 to 2.

5. The resin material according to claim 1, wherein the polyphenylene ether resin further includes a second polyphenylene ether, a third polyphenylene ether, or a combination thereof; wherein the second polyphenylene ether has a methacrylate group at a molecular end, and the third polyphenylene ether has a methacrylate group at a styryl group at a molecular end.

6. The resin material according to claim 1, wherein a number average molecular weight of the liquid rubber ranges from 2000 g/mol to 6000 g/mol.

7. The resin material according to claim 1, wherein a material for polymerizing the liquid rubber includes a butadiene monomer, and based on a total amount of the butadiene monomer being 100 mol %, 30 mol % to 90 mol % of the butadiene monomer has a side chain that contains an ethylene group after polymerization.

8. The resin material according to claim 1, wherein a material for polymerizing the liquid rubber includes a styrene monomer, and based on a total amount of the liquid rubber being 100 mol %, an amount of the styrene monomer ranges from 10 mol % to 50 mol %.

9. The resin material according to claim 1, wherein, based on a total weight of the resin composition being 100 phr, an amount of the inorganic fillers ranges from 20 phr to 150 phr.

10. The resin material according to claim 1, wherein the inorganic fillers are processed by a surface modification process to have at least one of a methacrylate group and an ethylene group.

11. The resin material according to claim 1, wherein the inorganic fillers include at least one of silicon dioxide, strontium titanate, calcium titanate, titanium dioxide, and alumina.

12. The resin material according to claim 1, wherein a purity of the inorganic fillers is higher than or equal to 99.8%.

13. The resin material according to claim 1, wherein an average particle size of the inorganic fillers ranges from 0.3 μm to 3 μm, and a maximum particle size of the inorganic fillers is smaller than 10 μm.

14. The resin material according to claim 1, further comprising a siloxane coupling agent which has at least one of a methacrylate group and an ethylene group.

15. The resin material according to claim 14, wherein, based on a total weight of the resin composition being 100 phr, an amount of the siloxane coupling agent ranges from 0.1 phr to 5 phr.

16. A metal substrate, comprising a base layer and a metal layer disposed on the base layer, wherein the base layer is formed from a resin material, the resin material includes a resin composition and inorganic fillers that is dispersed in the resin composition, and the resin composition includes:
10 wt % to 40 wt % of a liquid rubber;
20 wt % to 50 wt % of a polyphenylene ether resin, wherein the polyphenylene ether resin includes a first polyphenylene ether that has a bismaleimide group at a molecular end; and
10 wt % to 30 wt % of a crosslinker.

17. The metal substrate according to claim 16, wherein a dielectric dissipation factor of the resin material measured at 10 GHz is lower than or equal to 0.0016.

18. The metal substrate according to claim 16, wherein a dielectric constant of the resin material measured at 10 GHz is lower than or equal to 3.0.

19. The metal substrate according to claim 16, wherein a glass transition temperature of the resin material ranges from 150° C. to 250° C.

20. The metal substrate according to claim 16, wherein a peeling strength of the metal substrate ranges from 6.0 lb/in to 7.5 lb/in.
